(19) United States
(12) Patent Application Publication
(10) Pub. No.: US 2026/0182666 A1
(43) Pub. Date: Jul. 2, 2026

(54) AEROSOL GENERATING DEVICE AND HEATING MODULE

(71) Applicant: SHENZHEN FIRST UNION TECHNOLOGY CO., LTD., Shenzhen, Guangdong (CN)

(72) Inventors: Ruilong HU, Shenzhen, Guangdong (CN); Wei CHEN, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/868,472

(22) PCT Filed: May 23, 2023
(86) PCT No.: PCT/CN2023/095872

§ 371 Date: Nov. 22, 2024

(30) Foreign Application Priority Data
May 24, 2022 (CN) 202210575878.2

(51) Int. Cl. A24F 40/57; A24F 40/20; A24F 40/46; H05B 1/02; H05B 3/03

(52) U.S. Cl. CPC A24F 40/57; A24F 40/20; A24F 40/46; H05B 1/0202; H05B 3/03

(57) ABSTRACT

An aerosol generating device and a heating module are provided. The aerosol generating device includes a power supply assembly including a positive electrode output end and a negative electrode output end; a heating module including a plurality of heating members and a plurality of electrodes, the plurality of heating members including a first heating member and a second heating member, the plurality of electrodes including a first electrode, a second electrode and a third electrode, the first electrode being electrically connected to the first heating member, the second electrode being electrically connected to the first heating member and the second heating member, and the third electrode being electrically connected to the second heating member; and a switch control circuit, connected to the power supply assembly and the plurality of electrodes.

### CROSS-REFERENCE TO RELATED APPLICATIONS

This application claims priority to Chinese Patent Application No. 202210575878.2, filed with the China National Intellectual Property Administration on May 24, 2022 and entitled “AEROSOL GENERATING DEVICE AND HEATING MODULE”, which is incorporated herein by reference in its entirety.

### TECHNICAL FIELD

Embodiments of this application relate to the field of aerosol generating technologies, and in particular, to an aerosol generating device and a heating module.

### BACKGROUND

An aerosol generating device is configured to heat an aerosol generating product, to generate an aerosol.

The aerosol generating device includes a heating body configured to heat the aerosol generating product. However, during operation, the existing heating body usually generates heat in an entire section simultaneously in a non-diversified manner, which cannot meet a plurality of current heating requirements for the aerosol generating product.

### SUMMARY

Embodiments of this application provide an aerosol generating device and a heating module. A plurality of heating members are arranged. Electrodes that are in electrical conduction with a positive electrode output end and a negative electrode output end of a power supply assembly are selected and controlled according to a switch control circuit, so that the heating members in the heating module can have a plurality of heating modes to meet different heating requirements.

An embodiment of this application provides an aerosol generating device, including:
a power supply assembly, including a positive electrode output end and a negative electrode output end;
a heating module, the heating module including a plurality of heating members and a plurality of electrodes, the plurality of heating members including a first heating member and a second heating member, the plurality of electrodes including a first electrode, a second electrode and a third electrode, the first electrode being electrically connected to the first heating member, the second electrode being electrically connected to the first heating member and the second heating member, and the third electrode being electrically connected to the second heating member; and
a switch control circuit, connected to the power supply assembly and the plurality of electrodes so as to selectively allow electrical conduction between one of the first electrode, the second electrode and the third electrode and the positive electrode output end, and allow electrical conduction between the other two of the first electrode, the second electrode and the third electrode and the negative electrode output end.

An embodiment of this application provides a heating module, including a plurality of heating members and a plurality of electrodes;
the plurality of heating members include a first heating member and a second heating member, both of which are configured to heat an aerosol generating product; and
the plurality of electrodes include:
a first electrode, electrically connected to the first heating member;
a second electrode, electrically connected to the first heating member and the second heating member;
a third electrode, electrically connected to the second heating member; and
one of the first electrode, the second electrode, and the third electrode is a positive electrode, and the other two electrodes are both negative electrodes.

In the aerosol generating device and the heating module described above, the switch control circuit can control the positive electrode output end and the negative electrode output end of the power supply assembly to be in electrical conduction with different electrodes, so that different electrodes can become a negative electrode and a positive electrode. Therefore, the first heating member and the second heating member have a plurality of switchable operation modes. For example, the switch control circuit controls the second electrode to be in electrical conduction with the positive electrode output end, to allow the second electrode to become a positive electrode, and controls the first electrode and the third electrode to be in electrical conduction with the negative electrode output end separately or simultaneously, to allow at least one of the first electrode and the third electrode to become a negative electrode, so that the first heating member and the second heating member can perform heating separately or simultaneously in parallel. In another example, the switch control circuit controls the first electrode to be in electrical conduction with the positive electrode output end, to allow the first electrode to become a positive electrode, and controls the second electrode and the third electrode to be in electrical conduction with the negative electrode output end one after the other, to allow the second electrode and the third electrode to become negative electrodes one after the other, so that the first heating member may perform heating earlier than the second heating member, and a heating mode thereof may be: the first heating member performs heating alone, the first heating member and the second heating member perform heating simultaneously, or the like. In still another example, the switch control circuit controls the third electrode to be in electrical conduction with the positive electrode output end, to allow the third electrode to become a positive electrode, and controls the second electrode and the first electrode to be in electrical conduction with the negative electrode output end one after the other, to allow the second electrode and the first electrode to become negative electrodes one after the other, so that the second heating member may perform heating earlier than the first heating member, and a heating mode thereof may be: the second heating member performs heating alone, the second heating member and the first heating member perform heating simultaneously, or the like. Therefore, the aerosol generating device and the heating member in the heating module provided in this application have a plurality of operation modes and heating modes, so as to meet and adapt to a plurality of heating requirements.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of an aerosol generating device according to an embodiment of this application;

FIG. 2 is a cross-sectional view of an aerosol generating device according to an embodiment of this application;

FIG. 3 is a schematic exploded view of an aerosol generating device according to an embodiment of this application;

FIG. 4 is a schematic exploded view of a heating module according to an embodiment of this application;

FIG. 5 is another schematic exploded view of a heating module according to an embodiment of this application;

FIG. 6 is a cross-sectional view of a heating module according to another embodiment of this application;

FIG. 7 is a schematic transverse-sectional view of a heating module according to another embodiment of this application;

FIG. 8 is a schematic diagram of a heating assembly according to an embodiment of this application;

FIG. 9 is a schematic diagram of electrodes and heating members on the heating assembly provided in FIG. 8;

FIG. 10 is a schematic diagram of a heating assembly according to another embodiment of this application;

FIG. 11 is a schematic diagram of unfolding electrodes and heating members of the heating assembly provided in FIG. 10;

FIG. 12 is a schematic diagram of an equivalent circuit of electrodes and heating members on the heating assembly provided in FIG. 10;

FIG. 13 is a schematic diagram of another equivalent circuit of electrodes and heating members on the heating assembly provided in FIG. 10;

FIG. 14 is a schematic diagram of a heating assembly according to still another embodiment of this application;

FIG. 15 is a schematic diagram of unfolding electrodes and heating members of the heating assembly provided in FIG. 14;

FIG. 16 is a schematic diagram of selecting an electrode by a switch control circuit according to an embodiment of this application; and

FIG. 17 is a schematic transverse-sectional view of a heating module according to another embodiment of this application.

In the figures:
1. Aerosol generating product; 2. Receiving cavity; 3. Power supply assembly; 31. Circuit board; 32. Battery cell;
4. Heating module;
41. Heating assembly; 411. Heating member; 4111. First heating member; 4112. Second heating member; 412. Base body; 413. Accommodating cavity; 414. First electrode; 415. Second electrode; 416. Third electrode;
42. Temperature detection element; 43. Fixing member; 44. Heat insulation layer; 441. Avoidance groove; 45. Housing; 451. Heat preservation layer; 461. First holder; 462. Second holder; 471. First connecting member; 472. Second connecting member;
5. Switch control circuit; and 6. Air heater.

### DETAILED DESCRIPTION

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

The terms “first”, “second”, and “third” of this application are used for descriptive purposes only and should not be construed as indicating or implying relative importance or implicitly indicating the number or order of technical features indicated. All directional indications (for example, up, down, left, right, front, back) in the embodiments of this application are only used for explaining relative position relationships, movement situations or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

Embodiment mentioned in the specification means that particular features, structures, or characteristics described with reference to the embodiment may be included in at least one embodiment of this application. The term appearing at different positions of the specification may not refer to the same embodiment or an independent or alternative embodiment that is mutually exclusive with another embodiment. A person skilled in the art explicitly or implicitly understands that the embodiments described in the specification may be combined with other embodiments.

It should be noted that, when a component is referred to as “being fixed to” another component, the component may be directly on the other component, or an intervening component may be present. When an element is considered as “being connected to” another element, the element may be directly connected to the another element, or one or more intermediate elements may exist between the element and the another element. The terms “vertical”, “horizontal”, “left”, “right”, and similar expressions used in this specification are only for purposes of illustration but not indicate a unique implementation.

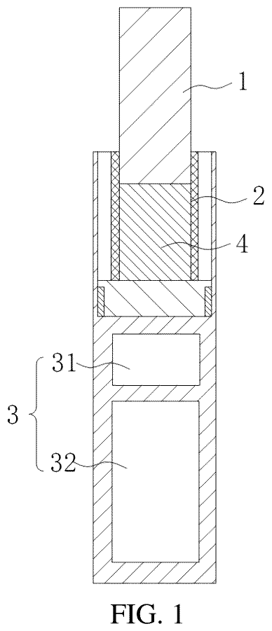

An embodiment of this application provides an aerosol generating device. The device may be configured to heat an aerosol generating product, so that the aerosol generating product is volatilized into an aerosol for inhalation. The aerosol may include Chinese herb, nicotine, or a flavor substance such as a tobacco spice. In this embodiment shown in FIG. 1, the aerosol generating product 1 is a tobacco product (such as a cigarette or cigar), but is not limited thereto.

In this embodiment shown in FIG. 1, the aerosol generating device includes a receiving cavity 2 configured to receive the aerosol generating product 1 and a heating module 4 configured to heat the aerosol generating product 1, and further includes a power supply assembly 3, and the power supply assembly 3 is configured to supply power for operation of the heating module 4.

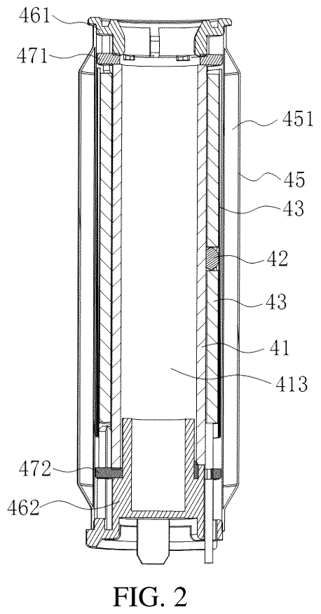

Referring to FIG. 1 and FIG. 2, the aerosol generating device has an insertion opening, and the aerosol generating product 1 is removably received in the receiving cavity 2 through the insertion opening. The heating module 4 has at least one part extending in a longitudinal direction in the receiving cavity 2, and generates heat through electromagnetic induction under a changing magnetic field, or generates heat through a resistor when being energized, or radiates infrared rays to the aerosol generating product 1 when being excited, to heat the aerosol generating product 1 (for example, a cigarette), and volatilize at least one component of the aerosol generating product 1 to form an aerosol for inhalation.

The power supply assembly 3 includes a battery cell 32 and a circuit board 31. The battery cell 32 is a rechargeable direct current battery cell that can output a direct current. The circuit board 31 is electrically connected to the rechargeable battery cell 32 to control output of a current, a voltage, or an electric power of the battery cell 32. In some embodiments, when a susceptor that can generate heat in a changing magnetic field is used as a heating member, the circuit board 31 may change a direct current outputted by the battery cell 32 into an alternating current, a changing magnetic field is generated under the alternating current by using a magnetic field generator (for example, an induction coil), and then the heating module 4 generates heat. In other embodiments, the battery cell 32 may alternatively be a disposable battery that is not rechargeable or does not need to be charged. In other embodiments, the power supply assembly 3 may be a wired power supply, and the wired power supply is directly connected to mains power through a plug to supply power to the aerosol generating device.

In an embodiment, a direct current supply voltage provided by the battery cell 32 ranges from 2.5 V to 9.0 V, and a direct current that can be provided by the battery cell 32 ranges from 2.5 A to 20 A.

Further, in an optional embodiment, the aerosol generating product 1 is preferably made of a tobacco-containing material that releases a volatile compound from the aerosol generating product 1 when being heated; or may be made of a non-tobacco material suitable for electric heating and smoking. The aerosol generating product 1 may be preferably made of a solid substrate, including one or more of powders, particles, fragmented strips, strips, or flakes of one or more of vanilla leaves, tobacco leaves, homogeneous tobacco, and expanded tobacco. Alternatively, the aerosol generating product 1 may include additional tobacco or non-tobacco volatile aroma compounds to be released when the aerosol generating product 1 is heated. In some optional embodiments, the aerosol generating product 1 is prepared in a shape of a conventional cigarette or cigar.

In the embodiments shown in FIG. 1 and FIG. 2, the heating module 4 includes a heating assembly 41. The heating assembly 41 may release energy and heat the aerosol generating product 1 by using the released energy, to allow the aerosol generating product to generate an aerosol.

In an embodiment, the heating assembly 41 includes a magnetic inductive material that can generate heat in a changing magnetic field, such as grade 430 stainless steel (SS430), grade 420 stainless steel (SS420), and an iron-nickel alloy material (such as permalloy), so that the heating assembly 41 can generate heat in the changing magnetic field, then generates heat spontaneously due to generation of eddy currents and magnetic hysteresis in the changing magnetic field, and conducts and/or radiates heat to the aerosol generating product 1, to heat the aerosol generating product 1. Correspondingly, the aerosol generating device further includes a magnetic field generator, such as an induction coil, configured to generate a changing magnetic field under an alternating current. The circuit board 31 is connected to the battery cell 32 and the induction coil, and may convert a direct current outputted by the battery cell 32 into an alternating current. Preferably, a frequency of the alternating current ranges from 80 KHz to 400 KHz. More specifically, the frequency may range from about 200 KHz to 300 KHz.

In an embodiment, the heating assembly 41 is made of a resistive conductive material including iron-chromium-aluminum alloy, nickel-chromium alloy, nickel-iron alloy, platinum, tungsten, silver, conductive ceramic, and the like, or made of a conductive material including at least one of the foregoing materials, and therefore can generate heat through a resistor when conducting electricity, to heat the aerosol generating product 1, to volatilize at least one component in the aerosol generating product 1 to form an aerosol.

In an embodiment, the heating assembly 41 is provided with a heating member 411. The heating member 411 may be an infrared electrothermal coating, a resistive film, a flexible heating film (such as an FPC heating film), or the like. The infrared electrothermal coating can be excited by a current provided by the battery cell 32 to radiate infrared rays to heat at least part of the aerosol generating product 1. When a wavelength of the infrared rays matches an absorption wavelength of the aerosol generating product 1, energy of the infrared rays is easily absorbed by the aerosol generating product 1. In an implementation of this application, the wavelength of the infrared rays is not limited and may be 0.75 μm to 1000 μm infrared rays, preferably 1.5 μm to 400 μm far infrared rays.

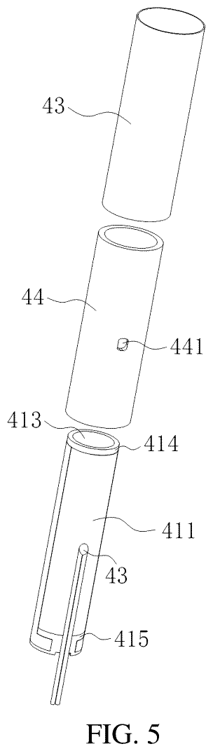

In an embodiment, the heating assembly 41 further includes a base body 412. The base body 412 serves as a carrier of the heating member 411 and is configured to support the heating member 411. Referring to FIG. 5, the base body 412 is constructed into a tubular body, in which an accommodating cavity 413 for accommodating the aerosol generating product 1 is provided, and the aerosol generating product 1 is heated in the accommodating cavity 413 to generate an aerosol. The heating member 411 may be arranged on an inner surface of the tubular body. A specific preparation manner may be to form the heating member 411 on the inner surface of the tubular body by electroplating. Alternatively, the base body 412 is configured to be inserted into the aerosol generating product 1.

The infrared electrothermal coating may be formed by infrared electric heating ink, ceramic powder, and an inorganic adhesive that are fully stirred, evenly coated on the outer surface of the base body 412, and then dried for solidification for a specified period of time. A thickness of the infrared electrothermal coating ranges from 30 μm to 50 μm. Certainly, the infrared electrothermal coating may also be formed by tin (IV) chloride, tin (II) oxide, antimony (III) chloride, titanium (IV) chloride, and anhydrous copper (II) sulfate that are mixed in a specified proportion, stirred, and coated on the outer surface of the base body 412. Alternatively, the infrared electrothermal coating may be one of a silicon carbide ceramic layer, a carbon fiber composite layer, a titanium zirconium oxide ceramic layer, a titanium zirconium nitride ceramic layer, a titanium zirconium boride ceramic layer, a titanium zirconium carbide ceramic layer, a ferric oxide ceramic layer, a ferric nitride ceramic layer, a ferric boride ceramic layer, a ferric carbide layer, a rare earth oxide ceramic layer, a rare earth nitride ceramic layer, a rare earth boride ceramic layer, a rare earth carbide layer, a nickel cobalt oxide ceramic layer, a nickel cobalt nitride ceramic layer, a nickel cobalt boride ceramic layer, a nickel cobalt carbide layer, or a high silica molecular sieve ceramic layer. The infrared electrothermal coating may alternatively be a coating made of another existing material.

In another embodiment, as shown in FIG. 5, the heating member 411 may be arranged on an outer surface of the tubular body. A preparation manner may be to arrange the heating member on the outer surface of the tubular body by plasma spraying or the like. In this case, the base body 412 may be made of a transparent material, for example, a quartz material, to increase a transmittance of infrared rays, so that the infrared rays can better radiate into the accommodating cavity 413.

The accommodating cavity 413 for accommodating the aerosol generating product 1 is provided inside the base body 412. To protect the heating member 411 and prevent the heating member from being corroded and damaged by the aerosol, the heating member 411 may be arranged on the outer surface of the base body 412, so as to isolate the infrared electrothermal coating from the aerosol. Alternatively, a protective layer may be arranged on the surface of the infrared electrothermal coating. The protective layer may be one or a combination of a polytetrafluroethylene layer and a glaze layer, or be made of another high temperature resistant material. The protective layer can isolate the infrared electrothermal coating from the aerosol and prevent wear of the infrared electrothermal coating. Therefore, the infrared electrothermal coating may be arranged on the inner surface of the base body 412 to come into contact with the aerosol generating product 1, thereby reducing energy loss by shortening a distance between the aerosol generating product 1 and the infrared electrothermal coating.

In an embodiment, as shown in FIG. 5, a wall thickness of the base body 412 is uniform, and on the base body, there are no obvious indentations and protrusions and there are no hollow holes and no blind grooves, to ensure that the heat is evenly distributed throughout the base body 412, thereby ensuring uniform heating of the aerosol generating product 1.

In an embodiment, the heating assembly 41 further includes a conductive module, and the conductive module includes a first electrode 414 and a second electrode 415 that are arranged on the base body 412. Both the first electrode 414 and the electrode 415 are at least partially electrically connected to the infrared electrothermal coating 411, so that a current can flow from one electrode to the other electrode through the infrared electrothermal coating. Polarities of the first electrode 414 and the second electrode 415 are opposite, for example: the first electrode 414 is a positive electrode, and the second electrode 415 is a negative electrode; or the first electrode 414 is a negative electrode, and the second electrode 415 is a positive electrode. If the heating member 411 is arranged on the outer surface of the base body 412, the first electrode 411 is arranged on the outer surface of the base body 412 close to one end, and the second electrode 415 is arranged on the outer surface of the base body close to the other end. If the heating member 411 is arranged on the inner surface of the base body 412, the conductive module may alternatively be arranged on the inner surface of the base body 412, or span the inner surface and the outer surface of the base body 412.

In an embodiment, both the first electrode 414 and the second electrode 415 are in a ring shape (a closed ring shape) or a strip shape (a non-closed ring shape or a bar shape). The first electrode 414 and the second electrode 415 may be ring-shaped conductive coatings or strip-shaped conductive coatings coated on the outer surface of the base body 412 and close to two opposite ends of the base body, and the conductive coatings may be made of silver, gold, palladium, platinum, copper, nickel, molybdenum, tungsten, niobium, or an alloy material of the foregoing metal. The first electrode 414 and the second electrode 415 may alternatively be ring-shaped conductive sheets or arc-shaped conductive sheets sleeved on the outer surface of the base body 412 and close to two opposite ends of the base body, and the conductive sheets are conductive sheets made of a metal material, for example, copper sheets or steel sheets.

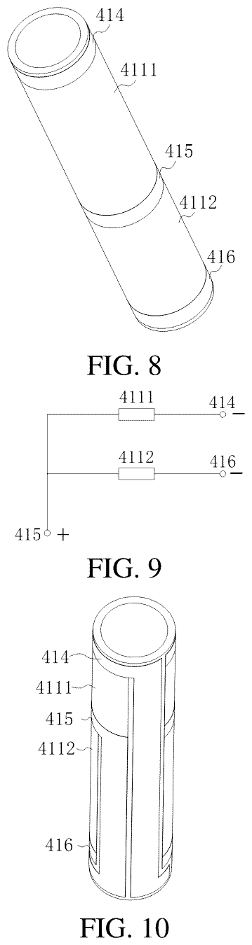

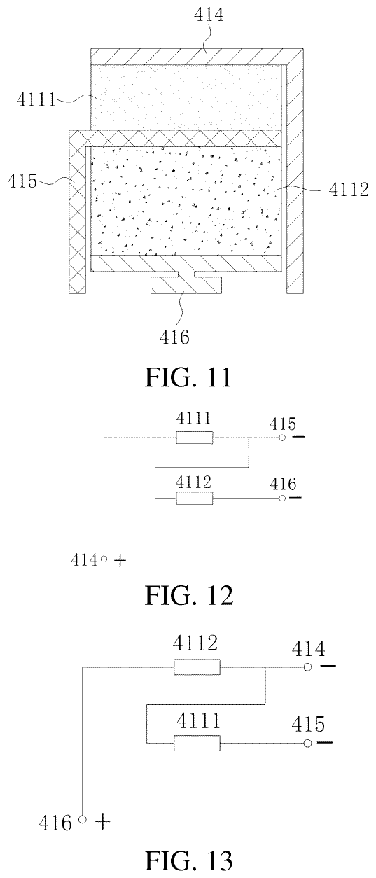

Referring to FIG. 8 to FIG. 15, there are two heating members 411, that is, a first heating member 4111 and a second heating member 4112, and the conductive module includes three electrodes, that is, a first electrode 414, a second electrode 415, and a third electrode 416. The first electrode 414 is electrically connected to the first heating member 4111, the third electrode 416 is electrically connected to the second heating member 4112, the first electrode 414 and the third electrode 415 are not in direct contact with each other and are spaced apart from each other, the second electrode 415 is electrically connected to both the first heating member 4111 and the second heating member 4112, and the first heating member 4111 is electrically connected to the second heating member 4112 by the connection of the second electrode 415.

Referring to FIG. 8, the first electrode 414, the second electrode 415, and the third electrode 416 are arranged on the base body 412, and the first electrode 414 and the third electrode 416 are respectively arranged on two opposite sides of the second electrode 415.

Referring to FIG. 10, the first electrode 414, the second electrode 415, and the third electrode 416 are arranged on the base body 412, and all extend to a same end portion of the base body 412.

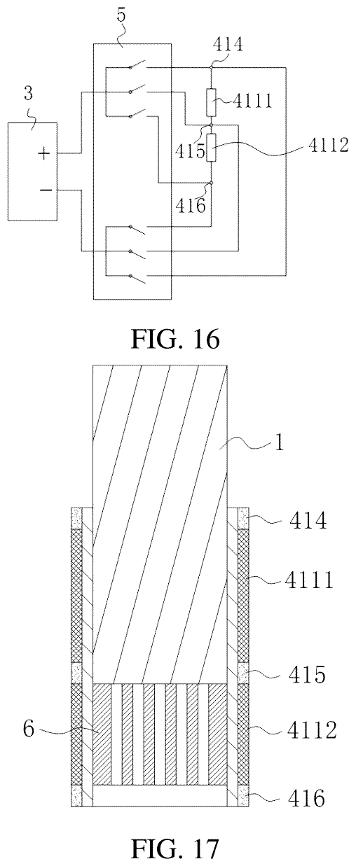

In an embodiment, as shown in FIG. 16, the power supply assembly 3 includes a positive electrode output end and a negative electrode output end. The positive electrode output end is configured to output a positive current or voltage, and the negative electrode output end is configured to output a negative current or voltage. The aerosol generating device further includes a switch control circuit 5. The switch control circuit 5 may be arranged on the circuit board 31. The switch control circuit 5 is connected to the power supply assembly 3 and the electrodes, to allow one or more of the plurality of electrodes to be in electrical conduction with the positive electrode output end, thereby forming one or more positive electrodes, and allow one or more of the plurality of electrodes to be in electrical conduction with the negative electrode output end, thereby forming one or more negative electrodes.

In an embodiment, as shown in FIG. 8, the second electrode 415 is a positive electrode configured to connect to a positive current or voltage, so that the second electrode 415 may form a common positive electrode of the first heating member 4111 and the second heating member 4112, and the first electrode 414 and the third electrode 416 are configured to connect to a negative current or voltage, and are both negative electrodes. This is a case that the second electrode 415 is in electrical conduction with the positive electrode output end and the other two electrodes are in electrical conduction with the negative electrode output end. In this case, an equivalent circuit shown in FIG. 9 shows a circuit layout of the first heating member 4111, the second heating member 4112, the first electrode 414, the second electrode 415, and the third electrode 416. That is, the first heating member 4111 and the second heating member 4112 are connected in parallel, so that the first heating member 4111 and the second heating member 4112 may be switched to perform heating separately, or may be switched to perform heating simultaneously. Therefore, the first heating member 4111 and the second heating member 4112 may perform segmented heating on the aerosol generating product 1, or perform heating on the aerosol generating product 1 in different time segments, or perform heating on the aerosol generating product 1 in a same time segment. That is, either the first electrode 414 or the third electrode 416 is in electrical conduction with the negative electrode output end, or the first electrode and the third electrode may be in electrical conduction with the negative electrode output end in different time segments.

In an embodiment, the second electrode 415 is a common positive electrode of the first heating member 4111 and the second heating member 4112. Therefore, when the first heating member 4111 and the second heating member 4112 perform heating simultaneously, the first heating member 4111 and the second heating member 4112 may have a same operation voltage. Therefore, heating efficiency of the first heating member 4111 and the second heating member 4112 is related to operation resistances of the first heating member 4111 and the second heating member 4112. According to a heating requirement, the first heating member 4111 and the second heating member 4112 may be set to have different operation resistances. The operation resistances of the first heating member 4111 and the second heating member 4112 are not specifically limited in this embodiment.

In an embodiment, in an aerosol flowing direction, the first heating member 4111 is located downstream of the second heating member 4112, the second heating member 4112 is configured to heat an upstream segment of the aerosol generating product 1, and the first heating member 4111 is configured to heat a relatively downstream segment of the aerosol generating product 1. In the aerosol generating product 1, air and/or the generated aerosol in the upstream segment of the aerosol generating product 1 has a high temperature under the action of the second heating member 4112, and flows into and heats the downstream segment of the aerosol generating product 1. In this case, heating efficiency of the first heating member 4111 may be less than heating efficiency of the second heating member 4112. The first heating member 4111 is configured to replenish the temperature of the air that flows into the downstream segment and perform auxiliary heating on the downstream segment of the aerosol generating product 1, so that the downstream segment of the aerosol generating product 1 generates an aerosol. In addition, heating power of the first heating member 4111 may be reduced, to further reduce power consumption of the aerosol generating device.

In an embodiment, to meet the need for quick aerosol output, the switch control circuit 5 of the aerosol generating device may be such arranged that the first heating member 4111 located downstream heats the aerosol generating product 1 in preference to the second heating member 4112, and aerosol generated in a downstream part of the aerosol generating product 1 may be preferably discharged, to shorten a distance by which the aerosol leaves the aerosol generating product 1, and avoid a case that the aerosol is cooled by another aerosol generating product 1 during flowing and condensed. Alternatively, when the first heating member 4111 generates heat alone, an input voltage or current is increased, so that the first heating member 4111 has higher heating power, to reduce an aerosol generating time.

In an embodiment, as shown in FIG. 10 to FIG. 13, in an aerosol flowing direction, the first heating member 4111 is located downstream of the second heating member 4112, the first electrode 414 electrically connected to the first heating member 4111 is a positive electrode, and the second electrode 415 and the third electrode 416 are negative electrodes. This is a case that the first electrode 414 is in electrical conduction with the positive electrode output end and the other two electrodes are in electrical conduction with the negative electrode output end. Therefore, the first electrode 414 may form a common positive electrode of the first heating member 4111 and the second heating member 4112. The third electrode 416 and the second electrode 415 are configured to be in electrical conduction with a negative electrode output end of the power supply assembly 3 in different time segments. That is, either the second electrode 415 or the third electrode 416 is in electrical conduction with the negative electrode output end, or the first electrode and the third electrode may be in electrical conduction with the negative electrode output end in different time segments.

An equivalent circuit shown in FIG. 12 shows a circuit layout of the first heating member 4111, the second heating member 4112, the first electrode 414, the second electrode 415, and the third electrode 416. In this case, when the first electrode 414 is in electrical conduction with the third electrode 416, the first heating member 4111 and the second heating member 4112 are connected in series, and operate simultaneously; and when the first electrode 414 is in electrical conduction with the second electrode 415, the first heating member 4111 operates, and the second heating member 4112 does not operate. Under the control of the switch control circuit 5, a case that the first electrode 414 forms a common positive electrode of the first heating member 4111 and the second heating member 4112 and a total input voltage of the heating module 4 remains unchanged is used as an example. In a first case, if the first heating member 4111 operates alone (the first electrode 414 and the second electrode 415 are in electrical conduction through the first heating member 4111), a voltage applied to the first heating member is greater than a voltage applied to the first heating member 4111 when the first heating member 4111 and the second heating member 4112 operate simultaneously (the first electrode 414 and the third electrode 416 are in electrical conduction through the first heating member 4111, the second electrode 415, and the second heating member 4112), so that when operation alone, the first heating member 4111 has a larger operation voltage because the voltage of the first heating member is not offloaded by the second heating member 4112, and then has larger heating efficiency. Therefore, the aerosol generating product 1 can quickly heat up, which helps reduce a waiting time for aerosol generating. In a second case, if the first heating member 4111 and the second heating member 4112 operate simultaneously, because the first heating member 4111 and the second heating member 4112 are connected in series, the voltage of the first heating member 4111 is offloaded by the second heating member 4112, so that a current flowing through the first heating member 4111 is reduced, and a current flowing through the second heating member 4112 is the same as or less than the current flowing through the first heating member 4111. Therefore, the first heating member 4111 and the second heating member 4112 can gently heat the aerosol generating product 1, to gradually release volatile substances evenly and fully. The first case and the second case may be arranged in different heating stages of the aerosol generating product 1 according to a heating requirement of the aerosol generating device. That is, the switch control circuit 5 is configured to first control electrical conduction between the first electrode 414 and the second electrode 415, and then control electrical conduction between the first electrode 414 and the third electrode 416, to allow the first heating member 4111 to generate heat earlier than the second heating member 4112.

Specifically, the switch control circuit 5 starts the heating module 4 to operate, so that the first electrode 414 is in electrical conduction with the second electrode 415, and the first heating member 4111 operates preferentially, to meet the need for quick aerosol output. Then, the first electrode 414 is in electrical conduction with the third electrode 416, the connection between the second electrode 415 and the negative electrode output end is interrupted or the second electrode 415 is floated, so that the first heating member 4111 and the second heating member 4112 operate together. It may be understood that the two negative electrodes are not in electrical conduction with the positive electrode simultaneously, to prevent the first heating member 4111 or the second heating member 4112 from being short-circuited.

As shown in FIG. 10 to FIG. 13, an extension length of the first heating member 4111 in the axial direction of the heating module 4 is less than an extension length of the second heating member 4112 in the axial direction of the heating module 4. On the premise that the first electrode 414 forms a common positive electrode of the first heating member 4111 and the second heating member 4112, the first heating member 4111 can quickly heat up the aerosol generating product 1 when operation alone, but inevitably heat the aerosol generating product 1 unevenly in the radial direction. Therefore, on the premise that the generated aerosol meets a puff, the axial length of the first heating member 4111 can be reduced, to reduce the waste of the aerosol generating product 1 on the periphery of the downstream segment of the aerosol generating product 1 corresponding to the first heating member 4111, and further help to save energy. That is, the length of the first heating member 4111 in the axial direction of the heating module 4 may be configured to be less than the length of the second heating member 4112 in the axial direction of the heating module 4. In another embodiment, when a direction of the current in the first heating member 4111 is the axial direction of the heating module 4, for example, axially upward or axially downward, a longer length of the first heating member 4111 in the axial direction of the heating module 4 indicates larger resistance of the first heating member. Therefore, under the same operation voltage, a shorter length of the first heating member 4111 in the axial direction of the heating module 4 indicates higher heating efficiency of the first heating member. Therefore, proper shortening of the length of the first heating member 4111 in the axial direction of the heating module 4 can increase heating efficiency of the first heating member 4111 when performing heating alone, thereby facilitating faster aerosol generating.

In another embodiment, the first heating member 4111 is located downstream of the second heating member 4112 in an aerosol flowing direction; and the third electrode 416 electrically connected to the second heating member 4112 is a positive electrode. Therefore, the third electrode 416 may form a common positive electrode of the first heating member 4111 and the second heating member 4112. This is a case that the third electrode 416 is in electrical conduction with the positive electrode output end and the other two electrodes are in electrical conduction with the negative electrode output end. The first electrode 414 and the second electrode 415 are configured to be in electrical conduction with a negative electrode output end of the power supply assembly 3 in different time segments. That is, either the first electrode 414 or the second electrode 415 is in electrical conduction with the negative electrode output end, or the first electrode and the third electrode may be in electrical conduction with the negative electrode output end in different time segments.

An equivalent circuit shown in FIG. 13 shows a circuit layout of the first heating member 4111, the second heating member 4112, the first electrode 414, the second electrode 415, and the third electrode 416. In this case, when the first electrode 414 is in electrical conduction with the third electrode 416, the connection between the second electrode 415 and the negative electrode output end is interrupted or the second electrode 415 is floated, and the first heating member 4111 and the second heating member 4112 are connected in series, and operate simultaneously; and when the third electrode 416 is in electrical conduction with the second electrode 415, the connection between the first electrode 414 and the negative electrode output end is interrupted or the first electrode 414 is floated, the second heating member 4112 operates, while the first heating member 4111 does not operate.

Under the control of the switch control circuit 5, a case that the third electrode 416 forms a common positive electrode of the first heating member 4111 and the second heating member 4112 and a total input voltage of the heating module 4 remains unchanged is used as an example. In a first case, if the second heating member 4112 operates alone (the third electrode 416 and the second electrode 415 are in electrical conduction through the second heating member 4112), a voltage applied to the second heating member is greater than a voltage applied to the second heating member 4112 when the first heating member 4111 and the second heating member 4112 operate simultaneously (the first electrode 414 and the third electrode 416 are in electrical conduction through the first heating member 4111, the second electrode 415, and the second heating member 4112), so that when operation alone, the second heating member 4112 has a larger operation voltage because the voltage of the second heating member is not offloaded by the first heating member 4111, and then has larger heating efficiency. In a second case, if the first heating member 4111 and the second heating member 4112 operate simultaneously, because the first heating member 4111 and the second heating member 4112 are connected in series, the voltage of the second heating member 4112 is offloaded by the first heating member 4111, so that a current flowing through the second heating member 4112 is reduced, and a current flowing through the first heating member 4111 is the same as or less than the current flowing through the second heating member 4112. Therefore, the first heating member 4111 and the second heating member 4112 can gently perform heating. The first case and the second case may be arranged in different heating stages of the aerosol generating product 1 according to a heating requirement of the aerosol generating device. That is, the switch control circuit 5 is configured to first control electrical conduction between the third electrode 416 and the second electrode 415, and then control electrical conduction between the first electrode 414 and the third electrode 416, to allow the second heating member 4112 to generate heat earlier than the first heating member 4111.

In an embodiment, referring to FIG. 17, on the premise that the third electrode 416 forms a common positive electrode of the first heating member 4111 and the second heating member 4112, the aerosol generating device further includes an air heater 6, where the first heating member 4111 is configured to heat or perform heat preservation for an aerosol generating product 1, and the second heating member 4112 is configured to heat the air heater 6.

The heating module 4 may be constructed into a tube shape, in which a cavity is provided. An upper end region of the cavity may be provided for the aerosol generating product 1 to be inserted, so as to accommodate the aerosol generating product 1, and the first heating member 4111 is arranged on a periphery of the aerosol generating product 1, so as to heat or perform heat preservation for the aerosol generating product 1. A lower end region of the cavity may be provided for the air heater 6 to be mounted, to accommodate the air heater 6. The air heater 6 may be in a porous structure made of a high heat conducting material, such as a honeycomb structure made of ceramic, graphite alloy, graphene, or the like, or the air heater 6 may be made of foamed metal, or the like. Any structure that can allow air to pass through and can heat up under the energy released by the second heating member 4112 to heat the flowing air may form the air heater 6 required in this embodiment. The second heating member 4112 is arranged on a periphery of the air heater 6, and is configured to heat the air heater 6, then the air heater 6 heats air flowing into the air heater to form the air into hot air, and the hot air continues to flow to enter the aerosol generating product 1, to bake the aerosol generating product 1.

On the premise that the third electrode 416 forms a common positive electrode of the first heating member 4111 and the second heating member 4112, the second heating member 4112 has a high heating power when performing heating alone, so that the air heater 6 can be quickly heated, and then hot air can be quickly formed. When the first heating member 4111 and the second heating member 4112 perform heating simultaneously, the heating power of both the first heating member 4111 and the second heating member 4112 is low, so that the first heating member 4111 can preheat and perform heat preservation for the aerosol generating product 1, and the second heating member 4112 can perform heat preservation for the air heater 6. Therefore, the switch control circuit 5 switches the negative electrode in electrical conduction with the third electrode 416 back and forth according to a preset frequency, or allows the third electrode 416 to be in electrical conduction with the second electrode 415 and the first electrode 414 in turn according to a preset frequency, to heat the aerosol generating product 1 and the air heater 6, so that the aerosol generating product 1 can be fully baked to generate an aerosol, and energy consumption can be greatly reduced, thereby saving energy.

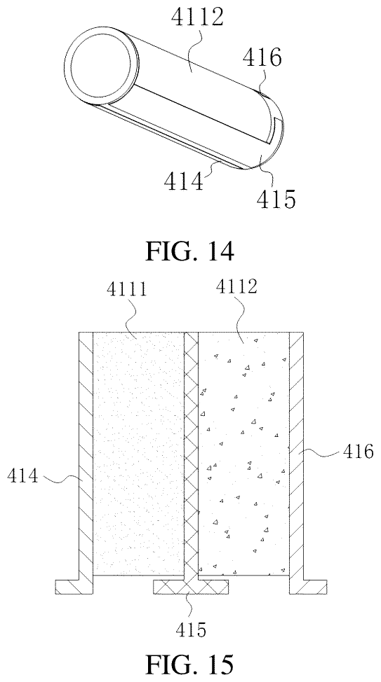

In an embodiment, as shown in FIG. 14 and FIG. 15, the first heating member 4111 and the second heating member 4112 separately extend in an axial direction of the heating module 4, and the first heating member 4111 and the second heating member 4112 are distributed in parallel in a circumferential direction of the heating module 4. In this case, the electrode connection between the first heating member 4111 and the second heating member 4112 may include the following three cases: Case (1): The second electrode 415 connected to both the first heating member 4111 and the second heating member 4112 is a common positive electrode, and the first electrode 414 and the third electrode 416 are negative electrodes. An equivalent circuit thereof is shown in FIG. 9. Case (2): The first electrode 414 is a positive electrode, and the second electrode 415 and the third electrode 416 are negative electrodes. It may be understood that the two negative electrodes are not in electrical conduction with the positive electrode simultaneously, to prevent the first heating member 4111 or the second heating member 4112 from being short-circuited. Case (3): The third electrode 416 is a positive electrode, and the second electrode 415 and the first electrode 414 are negative electrodes. It may be understood that the two negative electrodes are not in electrical conduction with the positive electrode simultaneously, to prevent the first heating member 4111 or the second heating member 4112 from being short-circuited. That is, one of the first electrode 414, the second electrode 415, and the third electrode 416 is in electrical conduction with the positive electrode output end, and the other two electrodes are in electrical conduction with the negative electrode output end. In other embodiments, there may be three or more heating members 411. Correspondingly, the electrodes may include a fourth electrode, a fifth electrode, and the like. When there are more than two heating members 411, the plurality of heating members 411 may be preferably electrically connected in sequence, and two adjacent heating members 411 may share one electrode. The positive electrode may form a common positive electrode of the plurality of heating members 411, and the remaining heating members 411 are electrically connected to the negative electrodes. Therefore, different negative electrodes may be selected to be in electrical conduction with the positive electrode, so that different heating members 411 are connected in series and participate in heating operation.

In an embodiment, as shown in FIG. 14 and FIG. 15, the first heating member 4111 and the second heating member 4112 are arranged distributively on the base body 412 in a circumferential direction of the base body 412; and the first electrode 414, the second electrode 415, and the third electrode 416 are arranged on the base body 412, and the first electrode 414 and the third electrode 416 are respectively arranged on two opposite sides of the second electrode 415.

In other embodiments, there may be three or more heating members 411. Correspondingly, the electrodes may include a fourth electrode, a fifth electrode, and the like. Therefore, the heating module 4 may include a plurality of heating groups. Each heating group includes a first heating member 4111 and a second heating member 4112, and further includes a first electrode 414, a second electrode 415, and a third electrode 416. The second electrode 415 is electrically connected to the first heating member 4111 and the second heating member 4112, the first electrode 414 is electrically connected to the first heating member 4111, the third electrode 416 is electrically connected to the second heating member 4112, one of the first electrode 414, the second electrode 415, and the third electrode 416 is a positive electrode, and the remaining two electrodes are negative electrodes. The plurality of heating groups are arranged at different positions on the heating module 4, so that the plurality of heating groups may generate heat cooperatively, for example, all the heating groups generate heat simultaneously at the same power (single-segment heating), or the plurality of heating groups generate heat at different times (segmented heating), or the plurality of heating groups generate heat simultaneously but at different powers, or the plurality of heating groups generate heat at different times selectively based on a condition preset by the switch control circuit 5.

In other embodiments, the heating members 411 are annular metal sheets, and the electrodes are also annular metal sheets. An electrode is electrically connected by nesting with a corresponding heating member 411, so as to jointly form a tube shape.

In other embodiments, through a preset program, the switch control circuit 5 automatically selects, according to an inhalation requirement, one of the electrodes to be in electrical conduction with the positive electrode output end of the power supply assembly 3 to become a positive electrode, and selects one or more of the remaining electrodes to be in electrical conduction with the negative electrode output end of the power supply assembly 3 to become one or more negative electrodes, so that an operation mode of the heating members can be selected, for example, a parallel relationship or a series relationship between the heating members can be determined. For example, the second electrode 415 that is electrically connected to both the first heating member 4111 and the second heating member 4112 is selected as a positive electrode. When both the first electrode 414 that is electrically connected to the first heating member 4111 and the third electrode 416 that is electrically connected to the second heating member 4112 are selected to be in electrical conduction with the negative electrode output end of the power supply assembly 3, the first heating member 4111 and the second heating member 4112 are connected in parallel to each other, and may simultaneously generate heat. When one of the first electrode 414 that is electrically connected to the first heating member 4111 and the third electrode 416 that is electrically connected to the second heating member 4112 is selected to be in electrical conduction with the negative electrode output end of the power supply assembly 3, either of the first heating member 4111 and the second heating member 4112 may independently generate heat. In another example, when the first electrode 414 electrically connected to the first heating member 4111 is selected as a positive electrode, and the third electrode 416 electrically connected to the second heating member 4112 is selected to be in electrical conduction with the negative electrode output end, the first heating member 4111 and the second heating member 4112 may be connected in series, and the first heating member 4111 and the second heating member 4112 simultaneously generate heat; and when the first electrode 414 electrically connected to the first heating member 4111 is selected as a positive electrode, and the second electrode 415 electrically connected to the second heating member 4112 is selected to be in electrical conduction with the negative electrode output end, the first heating member 4111 may generate heat alone, and the second heating member 4112 does not generate heat.

It may be understood that the positive electrode may be switched by the switch control circuit 5, so that any electrode may become the positive electrode. The negative electrodes can be switched by the switch control circuit 5, so that different electrodes can form the negative electrodes and are in electrical conduction with the positive electrode.

In other embodiments, when the positive electrode is determined, the switch control circuit 5 automatically selects, by using a preset program, a negative electrode that is preferentially in electrical conduction, or performs negative electrode switching. For example, when the first electrode 414 is a positive electrode, the first electrode 414 is automatically selected to be in electrical conduction with the second electrode 415 when the heating module 4 just starts, so that the third electrode 416 is turned off or floated, thereby enabling the first heating member 4111 to operate alone under a relatively high voltage. After 3s (not limited to this time), the circuit board 31 automatically switches the second electrode 415 and the third electrode 416, so that the third electrode 416 is in electrical conduction with the first electrode 414, and the second electrode 415 is floated or turned off, thereby enabling the first heating member 4111 and the second heating member 4112 to operate simultaneously.

In other embodiments, the switch control circuit may be manually controlled by using a key or a control panel, so that the switch control circuit 5 selects a positive electrode and a negative electrode that is in electrical conduction with the positive electrode.

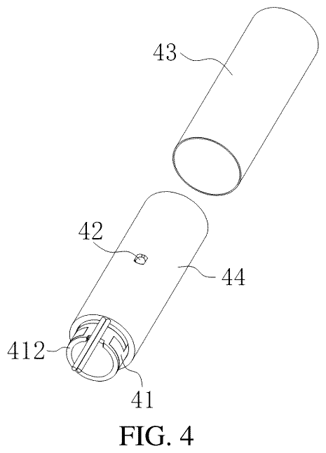

In the embodiments shown in FIG. 2 to FIG. 7, the heating module 4 further includes a temperature detection element 42. The temperature detection element 42 is configured to detect a real-time temperature of the heating assembly 41 and transfer information about the detected temperature to a controller on the circuit board 31. The controller controls power input to the heating assembly 41 according to the real-time temperature, to prevent the temperature of the heating assembly 41 from being excessively high or low, ensure the yield of the aerosol and the taste, and reduce the generation of harmful substances.

The temperature detection element 42 is in contact with the heating assembly 41, that is, collects the temperature of the heating assembly 41 through contact. The temperature detection element 42 may include an NTC (negative temperature coefficient) thermistor element, a PTC (positive temperature coefficient) thermistor element, or the like, and is not limited herein, as long as the temperature detection element can come into contact with the heating assembly 41 and can detect the temperature of the heating assembly 41 in real time. Certainly, it is not excluded that in other embodiments, a non-contact temperature detection device is used to detect the temperature of the heating assembly 41 in real time.

As shown in FIG. 5 to FIG. 7, the temperature detection element 42 is in direct contact with the infrared electrothermal coating 411 in the heating assembly 41, to improve accuracy and real-time performance of temperature detection. When the heating assembly 41 includes the foregoing base body 412, to prevent the temperature detection element 42 from occupying the accommodating cavity 413, thereby affecting the close fitting between the heating assembly 41 and the aerosol generating product 1, or affecting the insertion and removal of the aerosol generating product 1 relative to the accommodating cavity 413, the infrared electrothermal coating 411 is preferentially arranged on the outer surface of the base body 412, and the temperature detection element 42 is in contact with the infrared electrothermal coating 411 on the outer side of the base body 412. Optionally, the temperature detection element 42 is in surface contact with the heating assembly 41, to increase accuracy and sensitivity of temperature detection.

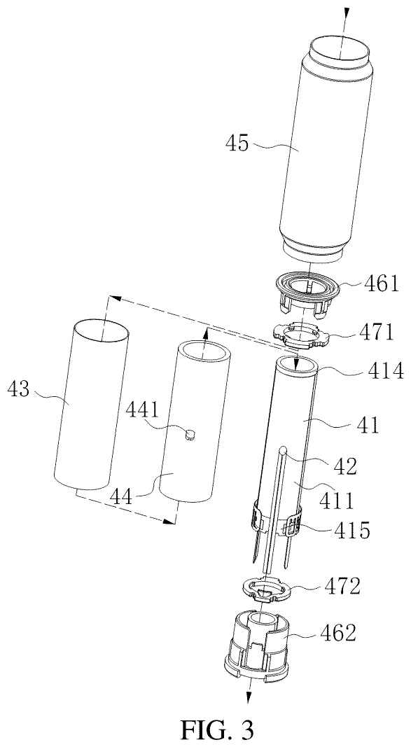

As shown in FIG. 3 to FIG. 7, the heating module 4 further includes a fixing member 43, and the fixing member 43 is configured to keep the temperature detection element 42 in contact with the heating assembly 41.

The fixing member 43 may be a heat shrinkable tube that contracts to implement tight hooping after being heated. After the heat shrinkable tube contracts, the heat shrinkable tube does not return to an original state. In other words, once the heat shrinkable tube contracts, the heat shrinkable tube can always press the temperature detection element 42 and the heating assembly 41 tightly. The heat shrinkable tube may be one of heat shrinkable tubes such as a PVC heat shrinkable tube, a PET heat shrinkable tube, a PTFE heat shrinkable tube, and a silicone heat shrinkable tube. A shrinkage ratio of the heat shrinkable tube may be 1.6:1 or 4:1. A shrinkage ratio of the heat shrinkable tube may alternatively be 1.8:1, 2.2:1, or 3.6:1. A shrinkage ratio of the heat shrinkable tube may alternatively be other ratios, which are not listed one by one herein. In other embodiments, the fixing member 43 may alternatively be an object such as an adhesive tape or a structural member that can keep the temperature detection element 42 in contact with the heating assembly 41 through bundling, clamping, or the like.

However, the heat shrinkable tube may melt and foam at a high temperature, and after melting, adhere to the infrared electrothermal coating arranged on the heating assembly 41. As the heating assembly 41 repeatedly generates heat and cools, the heat shrinkable tube cyclically expands and contracts, thereby tearing and destroying the infrared electrothermal coating 411. Alternatively, during rework and disassembly, the heat shrinkable tube tears and destroys the infrared electrothermal coating 411 due to adhesion. However, the costs of a heat shrinkable tube that can withstand a high temperature are very high. Therefore, in an embodiment, a heat insulation layer 44 may be arranged between the heating assembly 41 and the fixing member 43. The heat insulation layer 44 not only can prevent the temperature of the heating assembly 41 from being dissipated outward, but also can protect the fixing member 43, and prevent the fixing member from being damaged by the high temperature. In addition, the fixing member 43 is not in direct contact with the heating assembly 41, thereby protecting the infrared electrothermal coating 411 and preventing the infrared electrothermal coating from being damaged. Since the heat insulation layer 44 is arranged between the heater 41 and the fixing member 43, the fixing member 43 cannot be in direct contact with the heater 41, and the heat insulation layer 44 can isolate a large amount of heat dissipated by the heater 41 to the fixing member 43. Therefore, a heat shrinkable tube with a low temperature resistance can become the fixing member 43 described in this application, such as a PVC heat shrinkable tube or a PET heat shrinkable tube. In other words, a requirement for a material of the heat shrinkable tube can be reduced, and costs of the selected heat shrinkable tube can be reduced.

The heat insulation layer 44 may be made of one or more of aerogel, fiberglass felt, and heat insulation cotton. Optionally, the heat insulation layer 44 can adapt to a shape of a surface of the heating assembly 41, and therefore can be better attached to the surface of the heating assembly 41.

In an embodiment, as shown in FIG. 3 to FIG. 5, the heat insulation layer 44 is arranged on the surface of the heating assembly 41. An avoidance groove 441 is provided on the heat insulation layer 44. The temperature detection element 42 is arranged in the avoidance groove 441 and is in direct contact with the heating assembly 41 in the avoidance groove 441. In addition, a part of the temperature detection element 41 protrudes from the avoidance groove 441, so that the fixing member 43 can directly press the temperature detection element 42, the temperature detection element 42 is kept in contact with the heating assembly 41, and the temperature detection element 42 is limited in the avoidance groove 441, thereby ensuring that the temperature detection element 441 does not shake and is not displaced.

The heat insulation layer 44 can absorb the thickness of the temperature detection element 42 through the avoidance groove 441, to reduce a height of a bulge at a position where the fixing member 43 comes into contact with the temperature detection element 42, which can effectively prevent local excessive tightening or stress concentration of the fixing member 43, and help balance forces in positions on the fixing member 43, thereby slowing the aging speed of the fixing member 43 and prolonging the service life of the fixing member 43. In an optional embodiment, a lead of the temperature detection element 42 may be buried in the heat insulation layer 44, and preferably does not cause the outer surface of the heat insulation layer 44 to form a bulge.

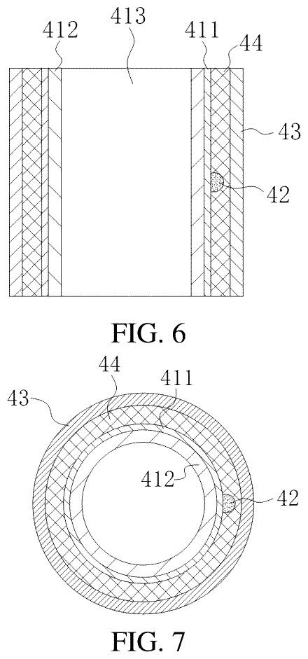

In an embodiment, as shown in FIG. 6 and FIG. 7, there is no avoidance groove 441 on the heat insulation layer 44, the heat insulation layer 44 covers the temperature detection element 42, and the temperature detection element 42 is arranged between the heat insulation layer 44 and the tubular body 41, so that the heat insulation layer 44 can have a relatively large thickness to absorb the thickness of the temperature detection element 42. Preferably, an outer surface on the heat insulation layer 44 corresponding to the temperature detection element 42 and an outer surface adjacent to the temperature detection element have the same curvature, that is, the temperature detection element 42 does not cause the outer surface of the heat insulation layer 44 to form a bulge, thereby facilitating arrangement of the fixing member 43 on the outer side of the heat insulation layer 44, and effectively preventing the fixing member 43 from being unevenly stressed due to a local bulge.

In an embodiment, the heat insulation layer 44 is in a shape of a plurality of sheets or blocks arranged intermittently, or the heat insulation layer 44 is not formed into an annular strip shape. The heat insulation layer 44 mainly plays a role in separation, to prevent the fixing member 43 from coming into direct contact with the heating assembly 41. In addition, the fixing member 43 tightly hoops the heat insulation layer 44, so that the heat insulation layer 44 is fixed on the heating assembly 41.

In another embodiment, as shown in FIG. 7, the heat insulation layer 44 is formed into a complete ring shape, and is arranged around the heating assembly 41 (in this case, the heating assembly 41 may be in a tubular shape, a sheet shape, or the like). Preferably, the heat insulation layer 44 has a uniform thickness throughout. If the heating assembly 41 is tubular, regardless of the shape of the outer contour of the cross-section of the heating member, the outer contour of the cross-section of the heat insulation layer 44 may be preferably formed into a circle, so that the fixing member 43 can be assembled more smoothly. The fixing member is arranged around the heat insulation layer, to tightly hoop the heat insulation layer to fix the heat insulation layer on the heating assembly.

Because a process is required to arrange the heat insulation layer 44 on the heating assembly 41, the temperature detection element 42 may be displaced in the process, or the temperature detection element 42 also needs to be taken into account in the process to prevent the temperature detection element from being separated from the heating assembly 41. To resolve this problem, in a preferred embodiment, the temperature detection element 42 may be preliminarily fixed on the heating assembly 41 by using a high-temperature adhesive first. The temperature detection element 42 is preferably kept in direct contact with the heating assembly 41 by bundling or covering and adhering with a high-temperature adhesive tape. The reason for selecting the high-temperature adhesive includes: The high-temperature adhesive has balanced thermal coefficients, and does not contract after being cured, so that the infrared electrothermal coating 411 is not damaged by tearing the infrared electrothermal coating 411 on the surface of the heating assembly 41 during expansion and contraction.

Similarly, a process is also required to arrange the fixing member 43 on the heat insulation layer 44. To prevent the heat insulation layer 44 from being displaced in the process, in a preferred embodiment, the heat insulation layer 44 may be preliminarily fixed on the heating assembly 41 by using a high-temperature adhesive first. The heat insulation layer 44 is preferably held on the heating assembly 41 by bundling or covering and adhering with a high-temperature adhesive tape. The high-temperature adhesive with balanced thermal coefficients and a low expansion and contraction rate is still used, so that a degree to which the heat shrinkable tube used as the fixing member 43 shrinks under heating is not affected, which can ensure maximum shrinkage of the heat shrinkable tube and squeeze the heat insulation layer 44 and the temperature detection element 42.

Referring to FIG. 2 and FIG. 3, the heating module 4 further includes a housing 45, a first holder 461, and a second holder 462. The first holder 461 is connected to an upper end of the heating assembly 41 and the housing 45, so that the upper end of the heating assembly 41 is positioned in the housing 45. The second holder 462 is connected to a lower end of the heating assembly 41 and the housing 45, so that the lower end of the heating assembly 41 is positioned in the housing 45. The first holder 461 and the second holder 462 may be made of a high-temperature-resistant plastic material, such as PEEK or PBI, which has low heat transfer efficiency, thereby effectively avoiding a case that the heat on the heating assembly 41 is transferred to the housing 45, resulting in heat loss and scalding of the housing 45.

However, when the temperature on the heating assembly 41 exceeds a melting threshold of the first holder 461 and the second holder 462, for example, exceeds 300° C., the first holder 461 and the second holder 462 may be deformed, thereby affecting fixing of the heating assembly 41. To resolve this problem, in a preferred embodiment, as shown in FIG. 2 and FIG. 3, the heating module 4 further includes a first connecting member 471 and a second connecting member 472. The first connecting member 471 and the second connecting member 472 may be made of ceramic that is more resistant to high temperature than the first holder 461 and the second holder 462. The first connecting member 471 connects the upper end of the heating assembly 41 and the first holder 461, so that the first holder 461 cannot be in direct contact with the heating assembly 41, thereby preventing the first holder 461 from being scorched by high temperature. The second connecting member 472 connects the lower end of the heating assembly 41 and the second holder 462, so that the second holder 462 cannot be in direct contact with the heating assembly 41, thereby preventing the second holder 462 from being scorched by high temperature. Therefore, the heating assembly 41 can adopt a larger heating power, which helps to shorten a waiting time for aerosol generating, can meet a requirement of the user for quick smoke emission, and can ensure a generation amount of aerosol per unit time, thereby facilitating improvement in the taste.

The first holder 461 and the first connecting member 471 may be riveted together in an interference fit manner, and the second holder 462 and the second connecting member 472 may be riveted together in an interference fit manner. The reason why the upper end of the heating assembly 41 is held in the housing 45 in such a manner that the first holder 461 and the first connecting member 471 cooperate with each other includes: A complex structure may be arranged on the first holder 461 through a process such as injection molding, to simplify the first connecting member 471 as much as possible, so that the first connecting member 471 made of ceramic can be modularly mass-produced, which helps reduce production costs and improve production efficiency. Similarly, the reason why the lower end of the heating assembly 41 is held in the housing in such a manner that the second holder 462 and the second connecting member 472 cooperate with each other also includes the foregoing reason.

In this embodiment shown in FIG. 2, the housing 45 includes a heat preservation layer 451. The heat preservation layer 451 is arranged on a periphery of the heating assembly 41, and is configured to prevent heat from leaking and perform heat preservation for the heating assembly 41. Preferably, the heat preservation layer 451 is a vacuum heat preservation layer, to improve the heat preservation effect.

In the aerosol generating device and the heating module described above, the switch control circuit can control the positive electrode output end and the negative electrode output end of the power supply assembly to be in electrical conduction with different electrodes, so that different electrodes can become a negative electrode and a positive electrode. Therefore, the first heating member 4111 and the second heating member 4112 have a plurality of switchable operation modes. For example, the switch control circuit controls the second electrode to be in electrical conduction with the positive electrode output end, to allow the second electrode to become a positive electrode, and controls the first electrode and the third electrode to be in electrical conduction with the negative electrode output end separately or simultaneously, to allow at least one of the first electrode and the third electrode to become a negative electrode, so that the first heating member 4111 and the second heating member 4112 can heat separately or simultaneously in parallel. In another example, the switch control circuit controls the first electrode to be in electrical conduction with the positive electrode output end, to allow the first electrode to become a positive electrode, and controls the second electrode and the third electrode to be in electrical conduction with the negative electrode output end one after the other, to allow the second electrode and the third electrode to become negative electrodes one after the other, so that the first heating member 4111 may perform heating earlier than the second heating member 4112, and a heating mode thereof may be: the first heating member 4111 performs heating alone, the first heating member 4111 and the second heating member 4112 perform heating simultaneously, or the like. In still another example, the switch control circuit controls the third electrode to be in electrical conduction with the positive electrode output end, to allow the third electrode to become a positive electrode, and controls the second electrode and the first electrode to be in electrical conduction with the negative electrode output end one after the other, to allow the second electrode and the first electrode to become negative electrodes one after the other, so that the second heating member 4112 may perform heating earlier than the first heating member 4111, and a heating mode thereof may be: the second heating member 4112 performs heating alone, the second heating member 4112 and the first heating member 4111 perform heating simultaneously, or the like. Therefore, the aerosol generating device and the heating member 411 in the heating module 4 provided in this application have a plurality of operation modes and heating modes, so as to meet and adapt to a plurality of heating requirements.

It should be noted that, the specification of this application and the accompanying drawings thereof illustrate preferred embodiments of this application, but this application is not limited to the embodiments described in the specification. Further, a person of ordinary skill in the art may make improvements or variations according to the foregoing descriptions, and such improvements and variations shall all fall within the protection scope of the appended claims of this application.

What is claimed is:

1. An aerosol generating device comprising:
a power supply assembly comprising a positive electrode output end and a negative electrode output end;
a heating module, the heating module comprising a plurality of heating members and a plurality of electrodes, the plurality of heating members comprising a first heating member and a second heating member, the plurality of electrodes comprising a first electrode, a second electrode and a third electrode, the first electrode being electrically connected to the first heating member, the second electrode being electrically connected to the first heating member and the second heating member, and the third electrode being electrically connected to the second heating member; and
a switch control circuit, connected to the power supply assembly and the plurality of electrodes so as to selectively allow electrical conduction between one of the first electrode, the second electrode and the third electrode and the positive electrode output end, and allow electrical conduction between the other two of the first electrode, the second electrode and the third electrode and the negative electrode output end.

2. The aerosol generating device according to claim 1, wherein the second electrode is allowed to be in electrical conduction with the positive electrode output end to become a positive electrode, and the first electrode and/or the third electrode are/is allowed to be in electrical conduction with the negative electrode output end to become negative electrodes/a negative electrode; or
the first electrode is allowed to be in electrical conduction with the positive electrode output end to become a positive electrode, and either the second electrode or the third electrode is allowed to be in electrical conduction with the negative electrode output end to become a negative electrode; or
the third electrode is allowed to be in electrical conduction with the positive electrode output end to become a positive electrode, and either the first electrode or the second electrode is allowed to be in electrical conduction with the negative electrode output end to become a negative electrode.

3. The aerosol generating device according to claim 2, wherein the switch control circuit is configured to separately control the two negative electrodes to be in electrical conduction with the positive electrode, to allow electrical conduction between the two negative electrodes and the positive electrode in different time segments.

4. The aerosol generating device according to claim 3, wherein the first electrode is in electrical conduction with the positive electrode output end to become a positive electrode, wherein the switch control circuit is configured to control either of the two negative electrodes to be in electrical conduction with the positive electrode, to allow the first heating member to generate heat alone, or the first heating member and the second heating member to generate heat simultaneously; or
the third electrode is in electrical conduction with the positive electrode output end to become a positive electrode, wherein the switch control circuit is configured to control either of the two negative electrodes to be in electrical conduction with the positive electrode, to allow the second heating member to generate heat alone, or the first heating member and the second heating member to generate heat simultaneously.

5. The aerosol generating device according to claim 1, wherein the switch control circuit is configured to separately control electrical conduction between the first electrode and the second electrode or electrical conduction between the second electrode and the third electrode, to allow the first heating member and the second heating member to generate heat in different time segments.

6. The aerosol generating device according to claim 5, wherein the second electrode is allowed to be in electrical conduction with the positive electrode output end to become a positive electrode; and the first electrode or the third electrode is allowed to be in electrical conduction with the negative electrode output end in different time segments to become a negative electrode.

7. The aerosol generating device according to claim 1, wherein the first heating member is located downstream of the second heating member in a direction of an aerosol outlet, the switch control circuit is configured to first control electrical conduction between the first electrode and the second electrode, and then control electrical conduction between the first electrode and the third electrode, to allow the first heating member to generate heat earlier than the second heating member.

8. The aerosol generating device according to claim 7, wherein the first electrode is allowed to be in electrical conduction with the positive electrode output end to become a positive electrode; and the switch control circuit is configured to control either the second electrode or the third electrode to be in electrical conduction with the negative electrode output end to become a negative electrode, and allow electrical conduction between the second electrode and the first electrode to be earlier than electrical conduction between the third electrode and the first electrode.

9. The aerosol generating device according to claim 1, wherein the first heating member is located downstream of the second heating member in a direction of an aerosol outlet, the switch control circuit is configured to first control electrical conduction between the second electrode and the third electrode, and then control electrical conduction between the first electrode and the third electrode, to allow the second heating member to generate heat earlier than the first heating member.

10. The aerosol generating device according to claim 9, wherein the third electrode is allowed to be in electrical conduction with the positive electrode output end to become a positive electrode; and the switch control circuit is configured to control either the first electrode or the second electrode to be in electrical conduction with the negative electrode output end to become a negative electrode, and allow electrical conduction between the second electrode and the third electrode to be earlier than electrical conduction between the first electrode and the third electrode.

11. The aerosol generating device according to claim 9, wherein the aerosol generating device further comprises an air heater, wherein the first heating member is configured to heat an aerosol generating product, and the second heating member is configured to heat the air heater.

12. A heating module, configured to heat an aerosol generating product, wherein the heating module comprises a plurality of heating members and a plurality of electrodes;
the plurality of heating members comprise a first heating member and a second heating member;
the plurality of electrodes comprise:
a first electrode, electrically connected to the first heating member;
a second electrode, electrically connected to the first heating member and the second heating member; and
a third electrode, electrically connected to the second heating member; and
one of the first electrode, the second electrode, and the third electrode is a positive electrode, and the other two electrodes are both negative electrodes.

13. The heating module according to claim 12, wherein the first heating member and the second heating member are arranged in an axial direction of the heating module.

14. The heating module according to claim 13, wherein the heating module further comprises a base body, and the first heating member and the second heating member are arranged distributively on the base body in an axial direction of the base body; and
the first electrode, the second electrode, and the third electrode are arranged on the base body, and all extend to a same end portion of the base body; or
the first electrode, the second electrode, and the third electrode are arranged on the base body, and the first electrode and the third electrode are respectively arranged on two opposite sides of the second electrode.

15. The heating module according to claim 13, wherein the first heating member is located downstream of the second heating member in a direction of an aerosol outlet, and a length of the first heating member in the axial direction of the heating module is less than a length of the second heating member in the axial direction of the heating module.

16. The heating module according to claim 12, wherein the first heating member and the second heating member are arranged in a circumferential direction of the heating module.

17. The heating module according to claim 16, wherein the heating module further comprises a base body, and the first heating member and the second heating member are arranged distributively on the base body in a circumferential direction of the base body; and
the first electrode, the second electrode, and the third electrode are arranged on the base body, and the first electrode and the third electrode are respectively arranged on two opposite sides of the second electrode.

18. The heating module according to claim 12, wherein the heating module further comprises a base body, the base body is a tubular body, and the first heating member and the second heating member are arranged on an outer surface of the base body; and
the base body is provided with an accommodating cavity for accommodating the aerosol generating product; or
the base body is configured to be inserted into the aerosol generating product.

19. The heating module according to claim 18, wherein at least one of the first heating member and the second heating member comprises an infrared electrothermal coating arranged on the outer surface of the base body.

20. The heating module according to claim 18, wherein at least one of the first electrode, the second electrode, and the third electrode is a conductive coating formed on the outer surface of the tubular body.
